(19) United States
(12) Patent Application Publication
(10) Pub. No.: US 2012/0002962 A1
(43) Pub. Date: Jan. 5, 2012

(54) WDM SIGNAL LIGHT MONITORING APPARATUS, WDM SYSTEM AND WDM SIGNAL LIGHT MONITORING METHOD

(76) Inventor: AKIHIRO TOSAKI, Tokyo (JP)

(21) Appl. No.: 13/151,847

(22) Filed: Jun. 2, 2011

(30) Foreign Application Priority Data
Jun. 30, 2010 (JP) 2010-148543

(51) Int. Cl. H04B 17/00

(52) U.S. Cl. 398/34

(57) ABSTRACT

A WDM signal light monitoring apparatus includes an optical delay interference circuit, a demultiplexer and a determiner. The optical delay interference circuit demultiplexes a phase-modulated WDM signal light, gives a delay difference to the demultiplexed WDM signal lights, then multiplexes the demultiplexed WDM signal lights, and thereby generates an intensity-modulated WDM signal light. The demultiplexer demultiplexes the intensity-modulated WDM signal light into signal lights of respective channels, and outputs the demultiplexed signal lights. The determiner determines the presence or absence of the signal light of each of the channels, based on the signal lights outputted from the demultiplexer.

This application is based upon and claims the benefit of priority from Japanese patent application No. 2010-148543, filed on Jun. 30, 2010, the disclosure of which is incorporated herein in its entirety by reference.

### BACKGROUND OF THE INVENTION

1. Field of the Invention

The present invention relates to a WDM signal light monitoring apparatus, a WDM system and a WDM signal light monitoring method which detect the presence or absence of a signal light of each of the channels.

2. Description of the Related Art

In recent years, an optical transmission apparatus using a Wavelength Division Multiplexing (WDM) technique has been generally introduced in areas ranging from a backbone to a metropolitan area because of increased communication capacity (a bit rate of 40 to 100 Gbps). In a WDM system constructed with such an optical transmission apparatus, the presence or absence of a signal light of each of channels needs to be detected for performing transmission signal quality control, system control and the like.

JP2009-290593A describes an example of a technique for monitoring the signal light of each of the channels in the WDM system. An optical transmission apparatus described in JP2009-290593A includes a demultiplexer at a post stage of an optical amplifier which amplifies a WDM signal light inputted from a transmission path. The optical transmission apparatus demultiplexes the WDM signal light amplified by the optical amplifier, into the signal lights of the respective channels. Then, the optical transmission apparatus determines the presence or absence of the signal light of each of the channels by detecting the level of each of the demultiplexed signal lights by a single PD (photodiode).

Moreover, JP2009-44327A describes another example of the technique for monitoring the signal light of each of the channels in the WDM system. A wavelength division multiplexing transmission apparatus described in JP2009-44327A uses a demultiplexer and a PD array to measure power levels in wavelength ranges (for example, 4 to 6 wavelengths for each channel), for a WDM signal light. Moreover, the wavelength division multiplexing transmission apparatus determines approximate waveforms of the respective channels from bit rates and modulation schemes of the respective channels. Then, the wavelength division multiplexing transmission apparatus approximates the above measured power levels in the wavelength ranges by the above determined approximate waveforms of the respective channels, and thereby determines the power levels and the wavelengths of the respective channels.

In recent years, the bit rate of the WDM signal light tends to be increased more and more because of the increased communication capacity. In addition, a phase modulation scheme is mainly used at a higher bit rate (40 to 100 Gbps). Spectral density and a peak power level of the signal light at the bit rate of 40 to 100 Gbps using the phase modulation scheme are decreased. Moreover, ASE (Amplified Spontaneous Emission) noise is accumulated by passing through optical amplifiers at many stages in the transmission path. For these circumstances, after passing through the optical amplifiers at many stages, the signal light at a high symbol rate includes a significantly degraded Signal-to-Amplified Spontaneous Emission noise ratio (S/ASE ratio).

The technique described in JP2009-290593A is configured to detect the level of the signal light of each of the channels by a PD. Thus, it is difficult to detect the presence or absence of the signal light using the phase modulation scheme.

Moreover, the technique described in JP2009-44327A is configured to sense the level of the signal light in the wavelength ranges for each channel. Thus, the signal light using the phase modulation scheme can also be monitored. However, the technique described in JP2009-44327A is configured to sense a level of a phase-modulated signal light itself. Thus, it is difficult to accurately detect the presence or absence of the signal light of each of the channels, due to an effect of the ASE noise.

### SUMMARY OF THE INVENTION

An object of the present invention is to provide a WDM signal light monitoring apparatus, a WDM system and a WDM signal light monitoring method which solve the above problem, that is, the problem that accuracy of detecting the presence or absence of a signal light of each of the channels is reduced due to the effect of ASE noise, as the symbol rate increases in the WDM system.

In order to achieve the above problem, the WDM signal light monitoring apparatus of the present invention includes an optical delay interference circuit which demultiplexes a phase-modulated WDM signal light, gives a delay difference to the demultiplexed WDM signal lights, then multiplexes the demultiplexed WDM signal lights, and thereby generates an intensity-modulated WDM signal light; a demultiplexer which demultiplexes the intensity-modulated WDM signal light into signal lights of respective channels; and a determiner which determines the presence or absence of the signal light of each of the channels, based on the demultiplexed signal lights.

Moreover, in order to achieve the above problem, the WDM system of the present invention includes:

the above WDM signal light monitoring apparatus; and

an optical switching device which outputs each of WDM signal lights split from optical splitter devices, to the monitoring apparatus in order at regular time intervals.

Moreover, in order to achieve the above problem, the WDM signal light monitoring method of the present invention is a WDM signal light monitoring method in a WDM signal light monitoring apparatus, the method including processes of:

demultiplexing a phase-modulated WDM signal light, giving a delay difference to the demultiplexed WDM signal lights, then multiplexing the demultiplexed WDM signal lights, and thereby generating an intensity-modulated WDM signal light;

demultiplexing the intensity-modulated WDM signal light into signal lights of respective channels; and

determining the presence or absence of the signal light of each of the channels, based on the demultiplexed signal lights.

With the above configurations, the present invention can detect the presence or absence of the signal light of each of the channels with high accuracy in the WDM system.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram showing a configuration of a first exemplary embodiment;

FIG. 2 is a block diagram showing a configuration of a second exemplary embodiment;

FIG. 3 is a diagram showing a configuration example of an optical delay interference circuit shown in FIG. 2;

FIG. 4 is a diagram for describing an operation of the optical delay interference circuit shown in FIG. 2;

FIG. 5 is a diagram showing an example of a relationship among frequency characteristics of a signal light and an ASE signal which enter a photoelectric converter shown in FIG. 2, a frequency band of a PD included in the photoelectric converter, and cutoff frequencies fL and fH of a band-pass filter;

FIG. 6 is a block diagram showing a configuration of a third exemplary embodiment;

FIG. 7 is a diagram showing an example of a relationship among the frequency characteristics of the signal light and the ASE signal which enter the photoelectric converter shown in FIG. 6, the frequency band of the PD included in the photoelectric converter, and cutoff frequency fH of a low-pass filter;

FIG. 8 is a block diagram showing a configuration of a fourth exemplary embodiment;

FIG. 9 is a diagram showing an example of a relationship among the frequency characteristics of the signal light and the ASE signal which enter the photoelectric converter shown in FIG. 8, and the frequency band of the PD included in the photoelectric converter; and

FIG. 10 is a block diagram showing a configuration of a fifth exemplary embodiment.

### EXEMPLARY EMBODIMENTS

Next, exemplary embodiments will be described in detail with reference to the drawings.

### First Exemplary Embodiment

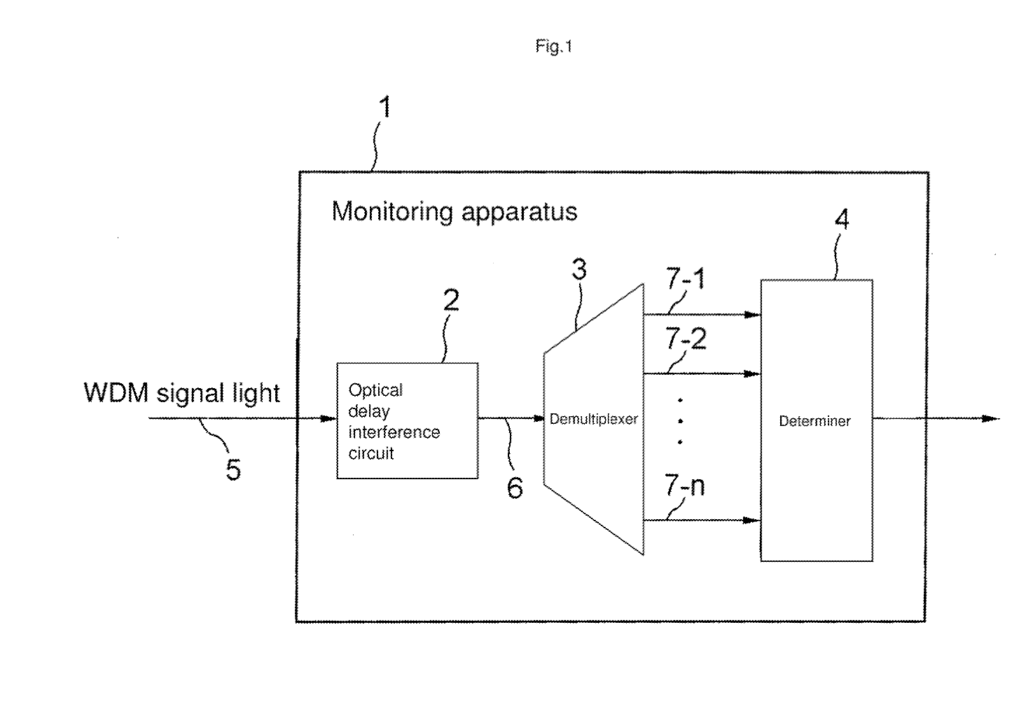

With reference to FIG. 1, WDM signal light monitoring apparatus 1 according to a first exemplary embodiment includes optical delay interference circuit 2, demultiplexer 3 and determiner 4.

Optical delay interference circuit 2 inputs phase-modulated WDM signal light 5, and outputs intensity-modulated WDM signal light 6. Specifically, optical delay interference circuit 2 first demultiplexes WDM signal light 5 into a first WDM signal light and a second WDM signal light at approximately the same level. Next, optical delay interference circuit 2 gives a predetermined delay difference between the first WDM signal light and the second WDM signal light. For example, if a modulation scheme of WDM signal light 5 is Differential Phase Shift Keying (DPSK), one signal light from among the first WDM signal light and the second WDM signal light is delayed by a time of one symbol relative to the time of one symbol of the other WDM signal light. Next, optical delay interference circuit 2 multiplexes the first WDM signal light and the second WDM signal light which have been given the delay difference, and thereby generates intensity-modulated WDM signal light 6. In other words, optical delay interference circuit 2 converts phase-modulated WDM signal light 5 into intensity-modulated WDM signal light 6. Then, optical delay interference circuit 2 outputs generated WDM signal light 6.

Demultiplexer 3 demultiplexes WDM signal light 6 outputted from optical delay interference circuit 2, into signal lights 7-1 to 7-n of respective channels.

Determiner 4 determines the presence or absence of the signal light of each of the channels, based on signal lights 7-1 to 7-n outputted from demultiplexer 3. For example, determiner 4 may include photoelectric converters which convert respective signal lights 7-1 to 7-n outputted from demultiplexer 3, into electrical signals, and output the converted electrical signals; filtering circuits to which the electrical signals outputted from these photoelectric converters are inputted, and which output signals obtained by filtering the inputted electrical signals; and a controller which determines the presence or absence of the signal light of each of the channels, based on a power of the output signal from each of these filtering circuits.

The above filtering circuit is desirably a filter with a characteristic of cutting a signal in a frequency band in which a level difference between the signal light and an ASE signal which enter the photoelectric converter becomes small. A band-pass filter, a low-pass filter, or a combination of filters such as the low-pass filter and the high-pass filter may be used as long as the filter includes such a characteristic. Moreover, photoelectric converters with a frequency characteristic that all or a part of the frequency band in which the level difference from the ASE signal becomes relatively small, in the frequency band of the signal light, is not included in a sensitivity wavelength range may be used. In this case, the filtering circuits can also be omitted.

The above controller determines the presence or absence of the signal light of each of the channels, based on the power of the output signal from each of the filtering circuits, or based on a power of the output signal from each of the photoelectric converters when the filtering circuits are omitted.

In this way, according to the present exemplary embodiment, the presence or absence of the signal light of each of the channels can be detected with high accuracy in a WDM system. This is because the intensity and the waveform of a not-phase-modulated and low-coherent ASE signal hardly change in the course of converting WDM signal light 5 into WDM signal light 6, and thus an S/ASE ratio of WDM signal light 6 is improved relative to WDM signal light 5.

### Second Exemplary Embodiment

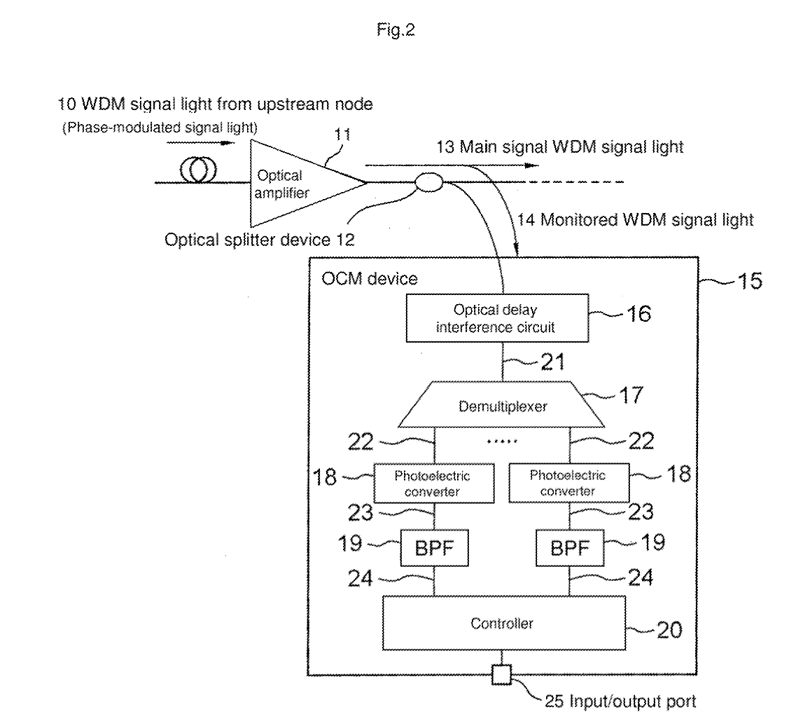

With reference to FIG. 2, the wavelength division multiplexing system as a second exemplary embodiment is shown. In FIG. 2, WDM signal light 10 transmitted from an upstream node is a signal light in which the number of channels is n (≧1), the wavelength of each channel is λ1 to λn, and the modulation scheme is phase modulation.

WDM signal light 10 goes through optical amplifier 11, and is split into main signal WDM signal light 13 and monitored WDM signal light 14 by optical splitter device 12. Main signal WDM signal light 13 is transmitted to a downstream node, and monitored WDM signal light 14 is inputted to OCM (Optical Channel Monitor) device 15 which is a monitoring apparatus.

OCM device 15 includes optical delay interference circuit 16, demultiplexer 17, photoelectric converters 18, band-pass filters (BPF) 19 which are the filtering circuits, and controller 20. Note that a determiner includes photoelectric converters 18, band-pass filters 19 and controller 20.

Optical delay interference circuit 16 is a circuit which converts monitored WDM signal light 14 which has been phase-modulated, into intensity-modulated WDM signal light 21. Optical delay interference circuit 16 demultiplexes phase-modulated monitored WDM signal light 14 into two signal lights each including almost half intensity. Then, optical delay interference circuit 16 delays one of the two signal lights by the time of one symbol, and subsequently multiplexes the two signal lights to cause the two signal lights to interfere with each other. Thereby, optical delay interference circuit 16 converts monitored WDM signal light 14 into intensity-modulated WDM signal light 21. Note that when one of the two signal lights is delayed, it may be delayed by a time equal to or longer than one symbol, for example, one symbol×n (n is a positive integer).

Demultiplexer 17 includes a function of demultiplexing intensity-modulated WDM signal light 21 into signal lights 22 for the respective wavelengths of the respective channels of WDM signal light 10.

Photoelectric converter 18 includes a photodiode or a photo detector (a photodiode+an amplifier). Photoelectric converter 18 generates electrical signal 23 at a level depending on the intensity of signal light 22 outputted from demultiplexer 17, and outputs generated electrical signal 23 to band-pass filter 19.

Band-pass filter 19 includes a characteristic of causing components in a frequency band ranging from cutoff frequency fL on the low-pass side to cutoff frequency fH on the high-pass side, in components of electrical signal 23 outputted from photoelectric converter 18, to pass through.

Controller 20 includes a function of determining the presence or absence of the signal light of each of the channels of WDM signal light 10, based on signal 24 outputted from band-pass filter 19, and of outputting the result of the determination from input/output port 25. The determination result outputted from input/output port 25 is transmitted to an external apparatus such as an optical amplifier or an apparatus system controller (not shown), and is used for transmission signal quality control, system control and the like in the WDM system. Moreover, various kinds of information, such as a threshold for determining the presence or absence of the signal light, can be inputted from the external apparatus via input/output port 25 to controller 20. For example, controller 20 includes a CPU (Central Processing Unit) and an FPGA (Field Programmable Gate Array) which are operated by a program.

Next, an operation of the present exemplary embodiment will be described.

WDM signal light 10 is transmitted via an optical fiber transmission path in the WDM system. When WDM signal light 10 goes through optical amplifier 11, ASE noise (amplified spontaneous emission noise) is added to WDM signal light 10 due to an internal characteristic of optical amplifier 11. WDM signal light 10 amplified by optical amplifier 11 is split by optical splitter device 12 for monitoring the output of the transmission path, and is caused to enter as monitored WDM signal light 14 into OCM device 15.

Monitored WDM signal light 14 entering OCM device 15 is first converted into intensity-modulated WDM signal light 21 in optical delay interference circuit 16.

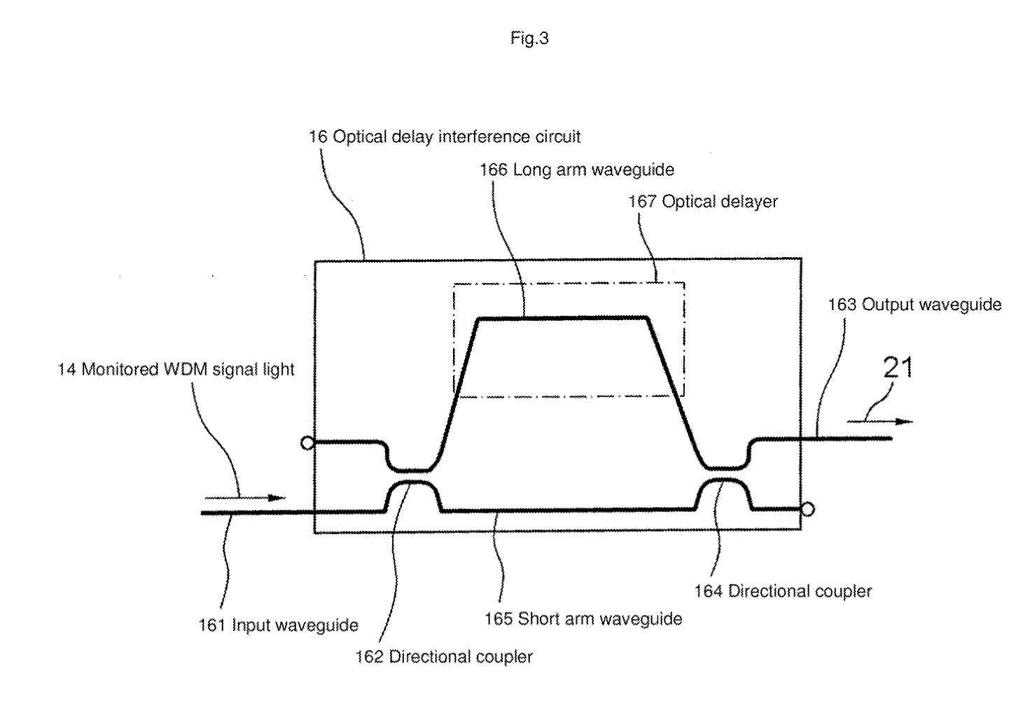

FIG. 3 is a diagram showing a configuration example of optical delay interference circuit 16 shown in FIG. 2.

With reference to FIG. 3, optical delay interference circuit 16 in this example includes a Mach-Zehnder interferometer. Optical delay interference circuit 16 includes input waveguide 161 on the input side, directional coupler 162 connected to input waveguide 161, output waveguide 163 on the output side, directional coupler 164 connected to output waveguide 163, as well as short arm waveguide 165 and long arm waveguide 166 which connect directional coupler 162 and directional coupler 164. Note that long arm waveguide 166 is longer by a waveguide length of a waveguide included in optical delayer 167, relative to short arm waveguide 165.

Monitored WDM signal light 14 which has been propagated through input waveguide 161 of optical delay interference circuit 16 is split into two waveguides, that is, long arm waveguide 166 and short arm waveguide 165, by directional coupler 162.

Monitored WDM signal light 14 split into short arm waveguide 165 is delayed by a time corresponding to a waveguide length of short arm waveguide 165, and then arrives at directional coupler 164. On the other hand, monitored WDM signal light 14 split into long arm waveguide 166 is delayed by a time corresponding to a waveguide length of long arm waveguide 166, and then arrives at directional coupler 164.

There is a difference corresponding to the waveguide length corresponding to optical delayer 167, between these waveguides. Thus, monitored WDM signal light 14 which has passed through long arm waveguide 166 is delayed by the delay time due to optical delayer 167, relative to monitored WDM signal light 14 which has passed through short arm waveguide 165, and arrives at directional coupler 164.

The delay time due to optical delayer 167 is set to a time corresponding to one symbol of the monitored WDM signal light (or may be set to a time equal to or longer than the above time). Consequently, in directional coupler 164, monitored WDM signal light 14 which has arrived via short arm waveguide 165 and monitored WDM signal light 14 which has arrived via long arm waveguide 166 interfere with each other. As a result, intensity-modulated WDM signal light 21 is outputted from directional coupler 164.

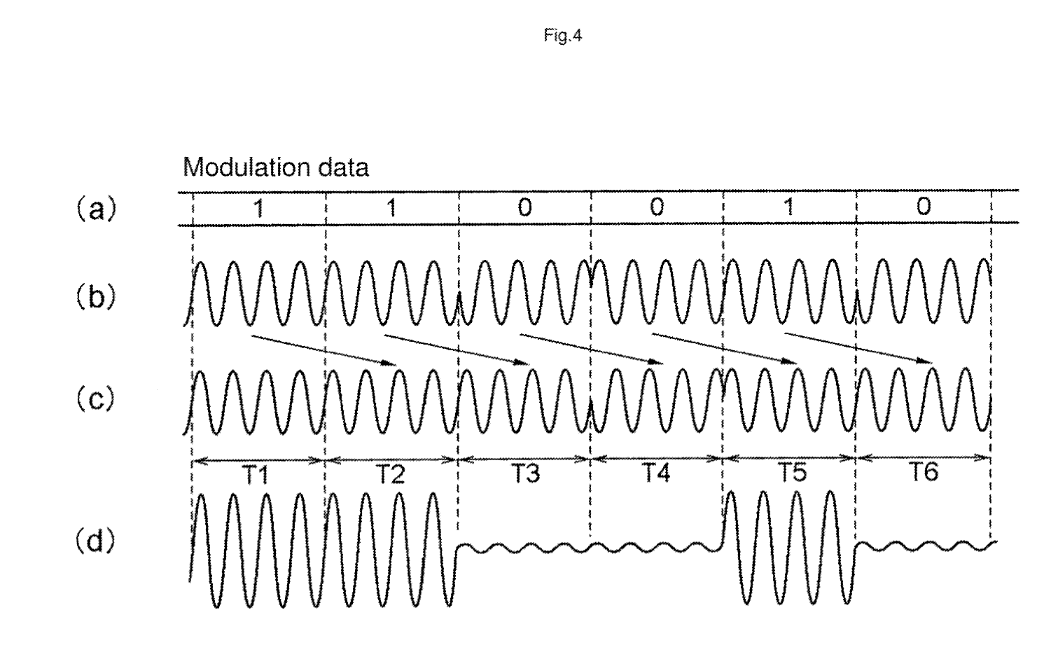

FIG. 4 is a diagram for describing an operation of optical delay interference circuit 16 shown in FIG. 2.

Here, as shown in FIG. 4(a), a case will be considered where phase modulation is performed by the DPSK scheme in which a phase changes by π when modulation data becomes zero, and the phase does not change when the modulation data becomes 1.

In this case, if the signal light which arrives at directional coupler 164 via short arm waveguide 165 is a signal light shown in FIG. 4(b), the signal light which arrives at directional coupler 164 via long arm waveguide 166 is delayed by the time corresponding to one symbol as shown in FIG. 4(c) and is multiplexed with the signal light of FIG. 4(b).

At this time, during time periods T1, T2 and T5 when two signal lights to be multiplexed are in phase, the two signal lights intensify each other, and during time periods T3, T4 and T6 when the two signal lights to be multiplexed are in reverse phase, the two signal lights attenuate each other. As a result, the signal light outputted from directional coupler 164 becomes an intensity-modulated signal light as shown in FIG. 4(d).

On the other hand, the ASE signal included in monitored WDM signal light 14 is not phase-modulated and is low-coherent, and thus the intensity and the waveform of the ASE signal hardly change before and after the multiplexing in directional coupler 164. Consequently, the S/ASE ratio of WDM signal light 21 outputted from optical delay interference circuit 16 is improved relative to monitored WDM signal light 14 inputted to optical delay interference circuit 16.

With reference to FIG. 2 again, in optical delay interference circuit 16, intensity-modulated WDM signal light 21 enters demultiplexer 17, and is demultiplexed into the respective wavelengths of the respective channels. Each of signal lights 22 demultiplexed into the respective wavelengths is applied with photoelectric conversion in photoelectric converter 18 corresponding to each of the channels, and then inputted to band-pass filter 19 corresponding to each of the channels. In the components of the input signal, band-pass filter 19 causes the components in the frequency band ranging from cutoff frequency fL to cutoff frequency fH, to pass through, and outputs the components to controller 20.

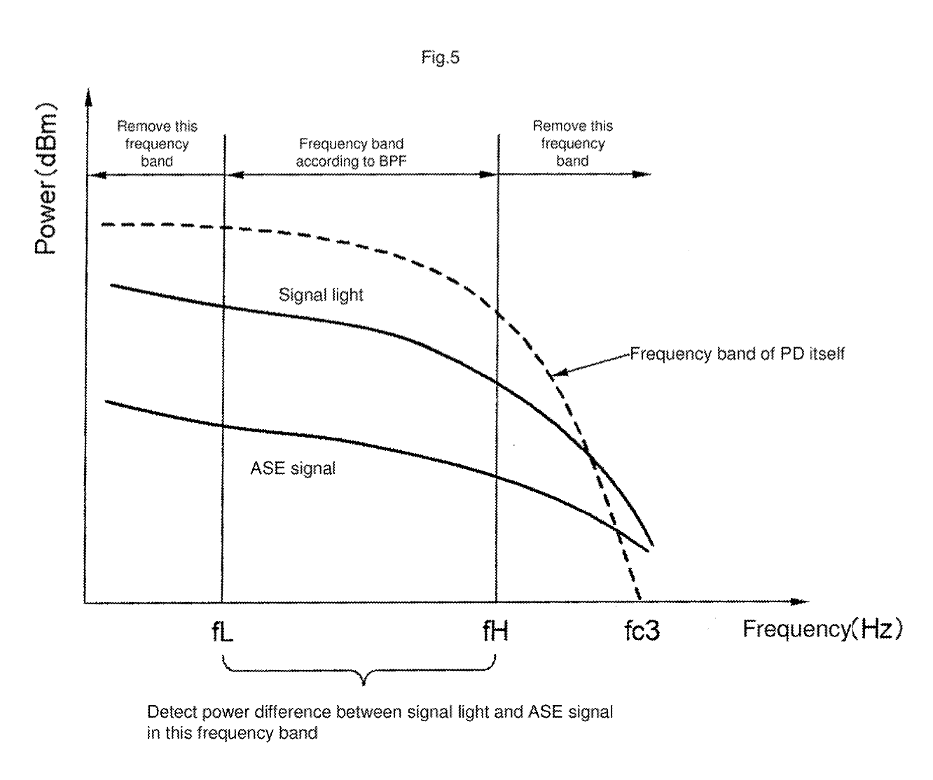

FIG. 5 is a diagram showing an example of a relationship among frequency characteristics of the signal light and the ASE signal which enter photoelectric converter 18 shown in FIG. 2, the frequency band of the PD included in photoelectric converter 18, and cutoff frequencies fL and fH of band-pass filter 19.

In the present exemplary embodiment, a PD including such a frequency band covering almost the entire frequency band of the signal light entering photoelectric converter 18 is used as photoelectric converter 18.

In the example of FIG. 5, a PD including a frequency band of fc3 (Hz) is used as photoelectric converter 18. The level difference between the signal light and the ASE signal which enter photoelectric converter 18 gradually becomes smaller as the frequency becomes higher. In the frequency band in which the level difference between the signal light and the ASE signal which enter photoelectric converter 18 is small, it becomes difficult to distinguish the signal light and the ASE signal from each other. Thus, a signal at a frequency equal to or higher than cutoff frequency fH is removed by band-pass filter 19.

Furthermore, the level of the ASE signal entering photoelectric converter 18 tends to increase as the frequency approaches zero. If the level of the ASE signal entering photoelectric converter 18 increases, it becomes difficult to distinguish the ASE signal from the signal light entering photoelectric converter 18, and thus a signal at a frequency equal to or lower than cutoff frequency fL is removed by band-pass filter 19. As a result, in the frequency band ranging from cutoff frequency fL to cutoff frequency fH, a sufficient level difference is caused between the signal light and the ASE signal which enter photoelectric converter 18.

For example, cutoff frequency fL is equal to or higher than 30 kHz or preferably 50 kHz. Moreover, for example, cutoff frequency fH is equal to or lower than “symbol rate/64 (=2⁶)” or preferably “symbol rate/128”. For example, if the symbol rate is 10 Gbps, cutoff frequency fH=10 Gbps/64=156 MHz, or preferably, cutoff frequency fH=10 Gbps/128=78 MHz.

With reference to FIG. 2 again, controller 20 detects a power difference between the signal light and the ASE signal in the frequency band ranging from cutoff frequency fL to cutoff frequency fH. Specifically, for each of the channels, controller 20 obtains power P1 of the output signal of band-pass filter 19 corresponding to the channel. Then, controller 20 subtracts power P2 preset as the power in a case where only the ASE signal is present, from this obtained P1, and compares P3 which is an absolute value of the remaining power, with a preset threshold Th. Then, as a result of the comparison, if P3>Th, controller 20 determines that the signal light is present, and if P3≦Th, controller 20 determines that the signal light is absent. Here, the presence of the signal light means that there is signal conduction of this wavelength in a transmission system, and the absence of the signal light means that there is no signal conduction of this wavelength in the transmission system.

For example, for the above calculation of power P1, a method can be used in which when a time domain (waveform) function representing the output signal of band-pass filter 19 is x(k), and a frequency domain function obtained by performing FFT (Fast Fourier Transform) on this time domain function x(k) is X(p), the sum of squares of the frequency domain function X(p) is set as power P1.

In this way, in the present exemplary embodiment, OCM device 15 detects the presence or absence of the signal light of each of the channels, based on WDM signal light 21 with the improved S/ASE ratio. Thus, the presence or absence of the signal light can be detected with high accuracy.

Moreover, in the present exemplary embodiment, OCM device 15 removes the components in the frequency band on the high-pass side and in the frequency band on the low-pass side, in which the level difference between the signal light and the ASE signal which enter photoelectric converter 18 is small, by using band-pass filter 19. Then, the OCM device determines the presence or absence of the signal light, based on the power of the output signal in the remaining frequency band. Thus, the accuracy of detecting the presence or absence of the signal light can be further increased.

### Third Exemplary Embodiment

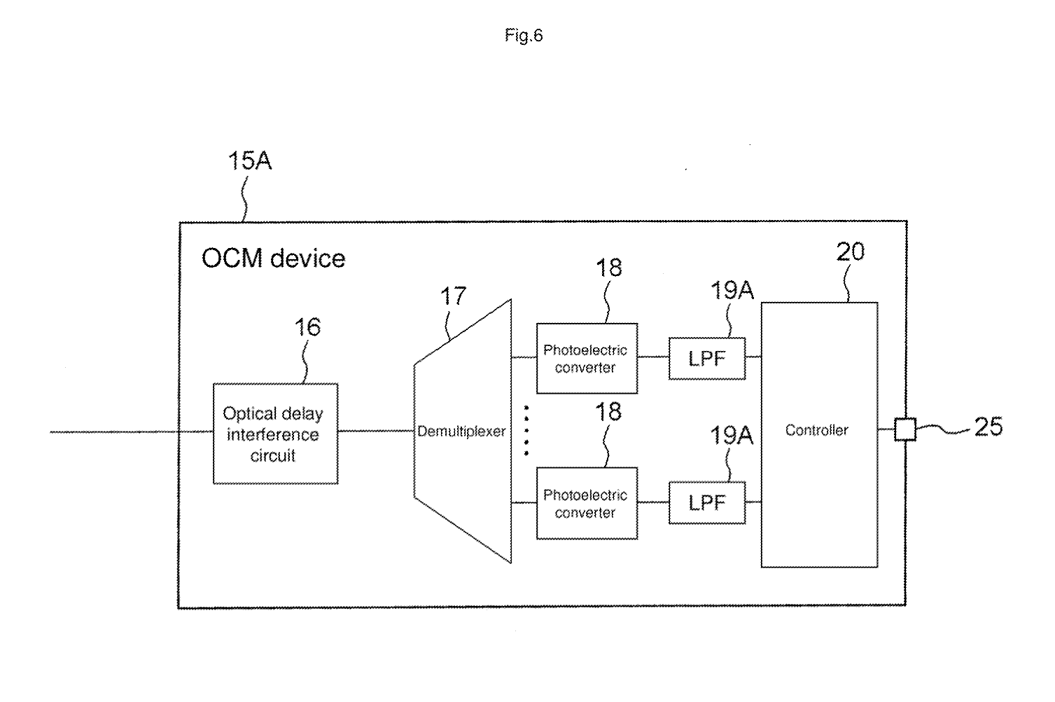

With reference to FIG. 6, OCM device 15A which is the monitoring apparatus according to a third exemplary embodiment is different from OCM device 15 shown in FIG. 2 in that OCM device 15A includes low-pass filter (LPF) 19A instead of band-pass filter 19.

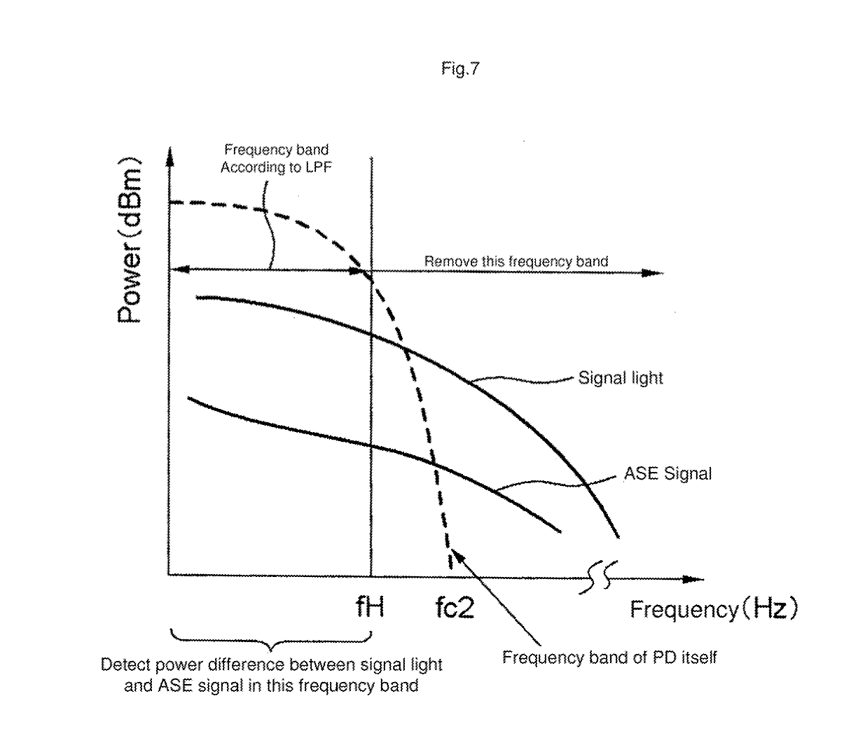

FIG. 7 is a diagram showing an example of a relationship among the frequency characteristics of the signal light and the ASE signal which enter photoelectric converter 18 shown in FIG. 6, the frequency band of the PD included in photoelectric converter 18, and cutoff frequency fH of low-pass filter 19A.

In the present exemplary embodiment, the signal at a frequency equal to or higher than cutoff frequency fH is removed by low-pass filter 19A. As described above, the level difference between the signal light and the ASE signal which enter photoelectric converter 18 gradually becomes smaller as the frequency becomes higher. In the frequency band in which the level difference between the signal light and the ASE signal which enter photoelectric converter 18 is small, it becomes difficult to distinguish the signal light and the ASE signal from each other. Thus, the signal at the frequency equal to or higher than cutoff frequency fH is removed by low-pass filter 19A.

For example, cutoff frequency fH is equal to or lower than “symbol rate/64 (=2⁶)” or preferably “symbol rate/128”. Moreover, the PD including such a frequency band that covers almost the entire frequency band of the signal light entering photoelectric converter 18 may be used as photoelectric converter 18. However, in the example of FIG. 7, a PD including a frequency band of frequency fc2 (Hz) (<frequency fc3) is used as photoelectric converter 18.

Controller 20 detects the power difference between the signal light and the ASE signal in the frequency band equal to or lower than cutoff frequency fH.

In this way, in the present exemplary embodiment, OCM device 15A detects the presence or absence of the signal light of each of the channels, based on WDM signal light 21 with the improved S/ASE ratio. Thus, the presence or absence of the signal light can be detected with high accuracy.

Moreover, in the present exemplary embodiment, OCM device 15A removes the component in the frequency band on the high-pass side in which the level difference between the signal light and the ASE signal which enter photoelectric converter 18 is small, by using low-pass filter 19A. Then, OCM device 15A determines the presence or absence of the signal light, based on the power of the output signal in the remaining frequency band. Thus, the accuracy of detecting the presence or absence of the signal light can be increased. However, in the present exemplary embodiment, the power is obtained by also including the frequency band close to the frequency zero at which the level of the ASE signal increases. Accordingly, the detection accuracy decreases relative to the second exemplary embodiment using the band-pass filter.

### Fourth Exemplary Embodiment

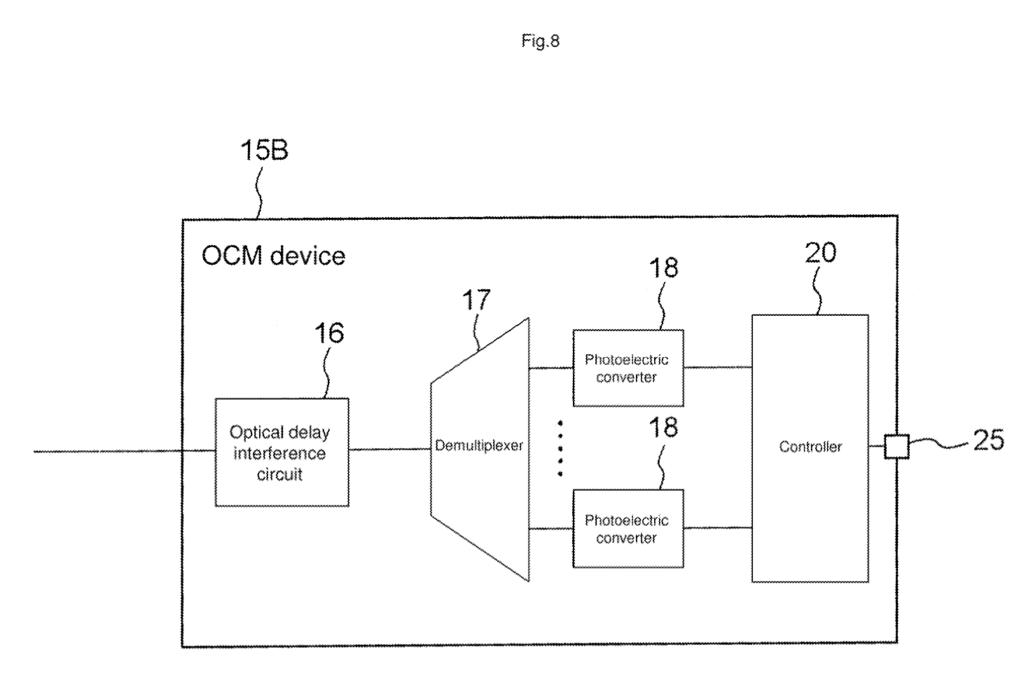

With reference to FIG. 8, OCM device 15B which is the monitoring apparatus according to a fourth exemplary embodiment is different from OCM device 15 shown in FIG. 2 in that OCM device 15B omits band-pass filter 19.

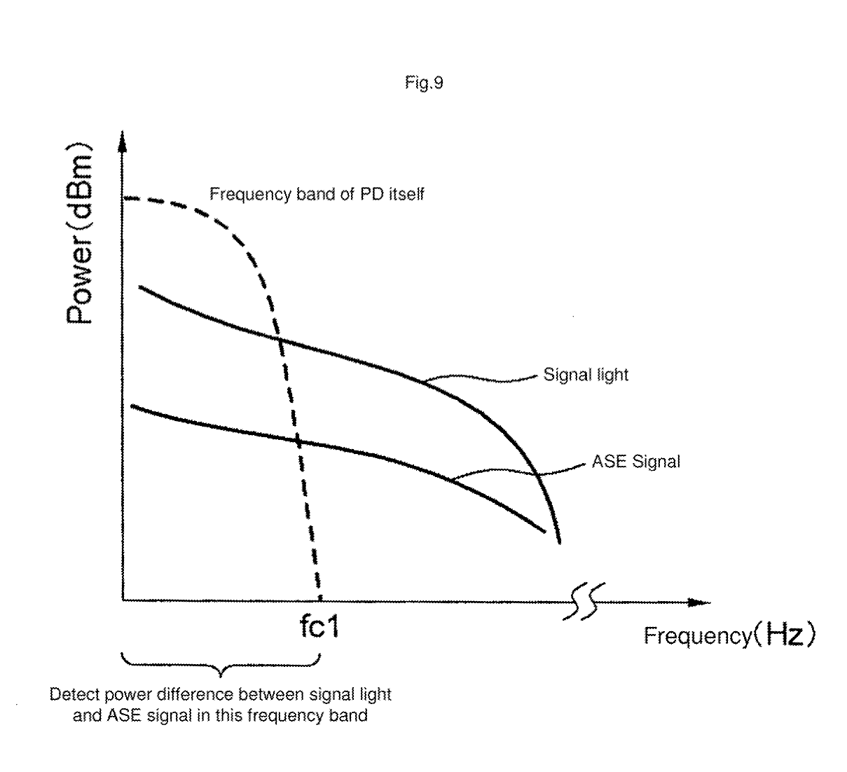

FIG. 9 is a diagram showing an example of a relationship among the frequency characteristics of the signal light and the ASE signal which enter photoelectric converter 18 shown in FIG. 8, and the frequency band of the PD included in photoelectric converter 18.

In the present exemplary embodiment, the PD that includes a kind of frequency band that covers almost the entire frequency band of the signal light entering photoelectric converter 18 is not used as photoelectric converter 18. Instead, a PD that includes a frequency band equal to or lower than frequency fc1 (Hz) which is lower than the upper limit frequency of the frequency band of the signal light entering photoelectric converter 18 is used as photoelectric converter 18. Frequency fc1 is desirably a value close to frequency fH in the second and third exemplary embodiments. As described above, the level difference between the signal light and the ASE signal which enter photoelectric converter 18 gradually becomes smaller as the frequency becomes higher. In the frequency band in which the level difference between the signal light and the ASE signal which enter photoelectric converter 18 is small, it becomes difficult to distinguish the signal light and the ASE signal from each other. Thus, a signal at a frequency equal to or higher than frequency fc1 is not applied with the photoelectric conversion.

Controller 20 detects the power difference between the signal light and the ASE signal in the frequency band equal to or lower than frequency fc1.

In this way, in the present exemplary embodiment, OCM device 15B detects the presence or absence of the signal light of each of the channels, based on WDM signal light 21 with the improved S/ASE ratio. Thus, the presence or absence of the signal light can be detected with high accuracy.

Moreover, in the present exemplary embodiment, OCM device 15B removes the component in the frequency band on the high-pass side in which the level difference between the signal light and the ASE signal which enter photoelectric converter 18 is small, by the frequency band of the photoelectric converter. Then, OCM device 15B determines the presence or absence of the signal light, based on the power of the output signal in the remaining frequency band. Thus, the accuracy of the detecting the presence or absence of the signal light can be increased. However, in the present exemplary embodiment, the power is obtained by also including the frequency band close to zero frequency at which the level of the ASE signal increases. Accordingly, the detection accuracy decreases relative to the second exemplary embodiment using the band-pass filter.

### Fifth Exemplary Embodiment

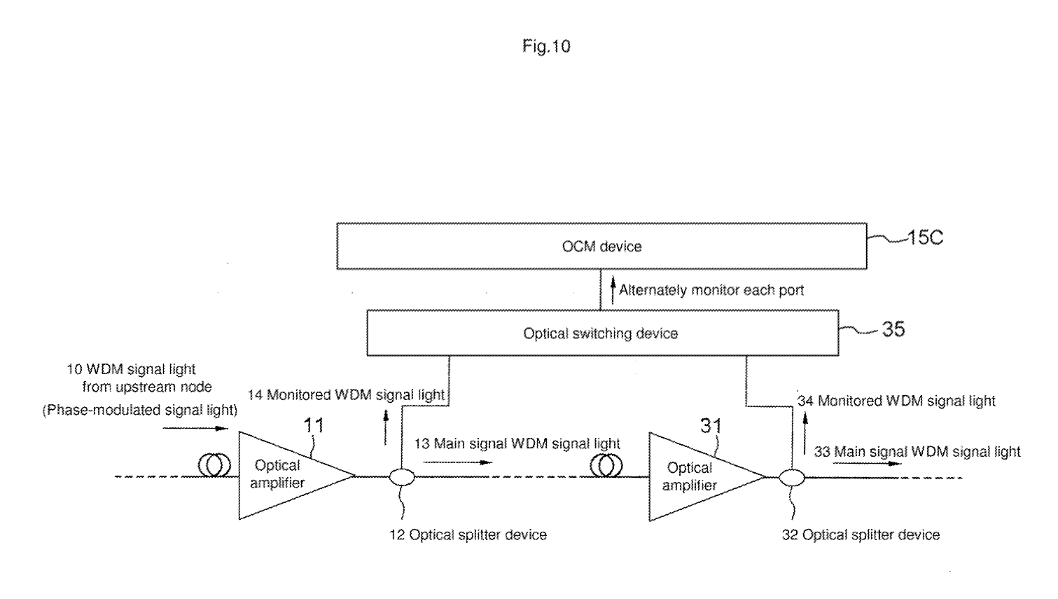

With reference to FIG. 10, in a fifth exemplary embodiment, OCM device 15C which is the monitoring apparatus is connected to optical splitter devices 12 and 32 via optical switching device 35, and is different from OCM device 15 shown in FIG. 2 which is connected only to optical splitter device 12.

Phase-modulated WDM signal light 10 transmitted from the upstream node is amplified in optical amplifier 11, and then split into main signal WDM signal light 13 and monitored WDM signal light 14 in optical splitter device 12. In these lights, monitored WDM signal light 14 is caused to enter optical switching device 35, and main signal WDM signal light 13 is transmitted to the downstream node.

Main signal WDM signal light 13 transmitted to the downstream node is amplified in optical amplifier 31, and then split into main signal WDM signal light 33 and monitored WDM signal light 34 in optical splitter device 32. Next, monitored WDM signal light 34 is caused to enter optical switching device 35, and main signal WDM signal light 33 is transmitted to a further downstream node.

Optical switching device 35 selects monitored WDM signal light 14 entering from optical splitter device 12 or monitored WDM signal light 34 entering from optical splitter device 32, in order at regular time intervals, and transmits the selected monitored WDM signal light to OCM device 15C. Moreover, optical switching device 35 may notify OCM device 15C of information indicating which monitored WDM signal light currently enters.

OCM device 15C includes a configuration similar to that of OCM device 15 shown in FIG. 2. Note that OCM device 15C may include a configuration similar to that of OCM device 15A shown in FIG. 6 or OCM device 15B shown in FIG. 8, instead of OCM device 15 shown in FIG. 2.

OCM device 15C determines the presence or absence of the signal light of each of the channels, based on the monitored WDM signal light inputted from optical switching device 35. In other words, while monitored WDM signal light 14 is inputted, OCM device 15C determines the presence or absence of the signal light of each of the channels of monitored WDM signal light 14. Moreover, while monitored WDM signal light 34 is inputted, OCM device 15C determines the presence or absence of the signal light of each of the channels of monitored WDM signal light 34. OCM device 15C operates similarly in either case. However, since the number of optical amplifiers through which monitored WDM signal light 34 has passed is larger relative to monitored WDM signal light 14, the S/ASE ratio of monitored WDM signal light 34 may be more degraded due to accumulated ASE signals. Consequently, separate values which are preset by OCM device 15C as the power in the case where only the ASE signal is present may be stored for monitored WDM signal light 14 and monitored WDM signal light 34.

The above described first to fifth exemplary embodiments have been described with the Differential Phase Shift Keying signal (DPSK) as an example of phase modulation. However, the present invention is also similarly applicable to a signal applied with multivalued phase modulation than the DPSK, by converting the phase-modulated signal light into a signal light applied with intensity-modulation by multivalued intensity modulation.

Moreover, in the above described first to fifth exemplary embodiments, the presence or absence of the signal light of the channel is determined based on the power in a predetermined frequency band of the signal light of the channel. In addition, for example, the presence or absence of the signal light of the channel may be determined based on the level of a particular frequency in the frequency band in which the level difference between the signal light and the ASE signal becomes small.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A WDM signal light monitoring apparatus, comprising:
an optical delay interference circuit which demultiplexes a phase-modulated WDM signal light, gives a delay difference to the demultiplexed WDM signal lights, then multiplexes the demultiplexed WDM signal lights, and thereby generates an intensity-modulated WDM signal light;
a demultiplexer which demultiplexes the intensity-modulated WDM signal light into signal lights of respective channels; and
a determiner which determines the presence or absence of the signal light of each of the channels, based on the demultiplexed signal lights.

2. The WDM signal light monitoring apparatus according to claim 1, wherein
the determiner comprises:
photoelectric converters which convert the respective demultiplexed signal lights into electrical signals, and output the respective converted electrical signals;
filtering circuits to which the respective electrical signals outputted from the respective photoelectric converters are inputted, and which output signals obtained by filtering the respective inputted electrical signals; and
a controller which determines the presence or absence of the signal light of each of the channels, based on a power of the output signal from each of the filtering circuits.

3. The WDM signal light monitoring apparatus according to claim 2, wherein each of the filtering circuits is a band-pass filter.

4. The WDM signal light monitoring apparatus according to claim 2, wherein each of the filtering circuits is a low-pass filter.

5. The WDM signal light monitoring apparatus according to claim 1, wherein
the determiner comprises:
photoelectric converters which convert the respective demultiplexed signal lights into electrical signals, and output the respective converted electrical signals;
a controller which determines the presence or absence of the signal light of each of the channels, based on a power of the output signal from each of the photoelectric converters.

6. The WDM signal light monitoring apparatus according to claim 5, wherein
each of the photoelectric converters includes a frequency band lower than an upper limit frequency of each of the demultiplexed signal lights.

7. A WDM system, comprising:
a WDM signal light monitoring apparatus according to claim 1; and
an optical switching device which outputs each of WDM signal lights split from optical splitter devices, to the monitoring apparatus in order at regular time intervals.

8. A WDM signal light monitoring method in a WDM signal light monitoring apparatus, the method comprising processes of:
demultiplexing a phase-modulated WDM signal light, giving a delay difference to the demultiplexed WDM signal lights, then multiplexing the demultiplexed WDM signal lights, and thereby generating an intensity-modulated WDM signal light;
demultiplexing the intensity-modulated WDM signal light into signal lights of respective channels; and
determining the presence or absence of the signal light of each of the channels, based on the demultiplexed signal lights.
